(19) United States
(12) Patent Application Publication
(10) Pub. No.: US 2002/0174247 A1
(43) Pub. Date: Nov. 21, 2002

(54) System and method for dynamic routing to service providers

(76) Inventor: Bo Shen, Fremont, CA (US)

Correspondence Address: HEWLETT-PACKARD COMPANY, Intellectual Property Administration, P.O. Box 272400, Fort Collins, CO, 80527-2400, US

(21) Appl. No.: 09/825,495

(22) Filed: Apr. 2, 2001

(51) Int. Cl. G06F 15/173

(52) U.S. Cl. 709/238

(57) ABSTRACT

The invention provides a method and apparatus for intelligently routing client requests to service provider servers associated with a service routing network, which may include an association of multiple service provider servers. An ingress server may be configured to receive incoming client requests directed to the network. The associated servers may be pre-qualified and monitored by one or more servers within the network to keep the ingress server apprised of their status. The requests may then be intelligently qualified and routed to an associated server according to predetermined criteria. The association of these servers allows for easy, convenient and intelligent routing between the providers and specific clients according to the individual client's requests.

### BACKGROUND

The invention is directed to routing client requests in a network and, more particularly, to intelligent routing of client requests to service providers communicating within a service routing network.

Organized routing of client requests, such as Internet or other network browser requests, within a network is a widely practiced area, having numerous applications. This is particularly true in conventional Internet applications and related solutions. One such field of routing technology is directed to connecting Internet browsers, an example of a client, with service providers. In conventional applications, service providers do not advertise to clients. A client looking for a service provider must somehow search out for providers of a particular service. Then, once some are found, the client must discern among a number of service options and parameters to determine which provider to employ. This can be a tedious and uncertain task.

For example, one type of service provider may be a video data service. Such a service may offer video editing, adding content to video, and performing other operations by manipulating and adding data. Some such service providers may even specialize in processing wedding videos, including editing the video, adding content such as titles and background music, and performing other processes on the video data. A client looking for such a service provider would need to perform the arduous task of searching one out that happens to provide such unique services. Conventional methods would first require the searching out of services providers, perhaps using a boolian word search to find a variety of such providers. Then, the client must comb through the search results according to the client's particular criteria, perhaps narrowing down the search terms and trying over again. It may be further required to search through actual provider websites to determine whether the service that a client is looking for is available.

Thus, it would be useful to provide a system and method for simplifying the task of searching for such a service by allowing a client to intelligently search for a service. It would also be useful to help a client to choose from among several providers without having to find and qualify them. As will be seen, the invention does this in an elegant manner.

### SUMMARY OF THE INVENTION

The invention provides a method and apparatus for intelligently routing client requests to service provider servers associated with a service routing network. The service routing network may include an association of multiple service provider servers. The association of servers may include an ingress server configured to receive incoming requests for services that are directed to the network. The associated servers may be pre-qualified and monitored within the network to apprise the ingress server of their status. The ingress server may then intelligently qualify and route the client service request to an associated server according to predetermined criteria. The ingress server may be configured with the most current server information, such as updated service provider tables, and can then more efficiently connect clients with the most relevant servers. The association of these servers allows for easy, convenient and intelligent routing between the providers and specific clients according to the individual client's requests.

### BRIEF DESCRIPTION OF THE DRAWINGS

FIG. 1 is a diagrammatic view of a system for routing service providers according to the invention is illustrated;

FIG. 2 is a flow chart illustrating a method for routing service providers according to the invention;

FIG. 3 is a flow chart illustrating a method for qualifying a service provider according to the invention;

FIG. 4 is a flow chart illustrating a method of establishing an association with a service provider according to the invention;

FIG. 5 is a flow chart illustrating a method for routing service providers according to the invention; and

FIG. 6 is a diagrammatic view of a system for routing service providers according to the invention is illustrated.

### DETAILED DESCRIPTION OF PREFERRED EMBODIMENTS

The invention provides a method and apparatus for intelligently routing client requests to service provider servers associated with a service routing network, which may include an association of multiple service provider servers. An ingress server may be configured to receive incoming client requests directed to the network. The associated servers may be pre-qualified and monitored by one or more servers within the network to keep the ingress server apprised of their status. The requests may then be intelligently qualified and routed to an associated server according to predetermined criteria. The association of these servers allows for easy, convenient and intelligent routing between the providers and specific clients according to the individual client's requests. The invention is particularly adapted to routing client requests within a network, and will be described in that context. It will be appreciated, however, that this is illustrative of only one utility of the invention, and that the invention has greater applicability and utility.

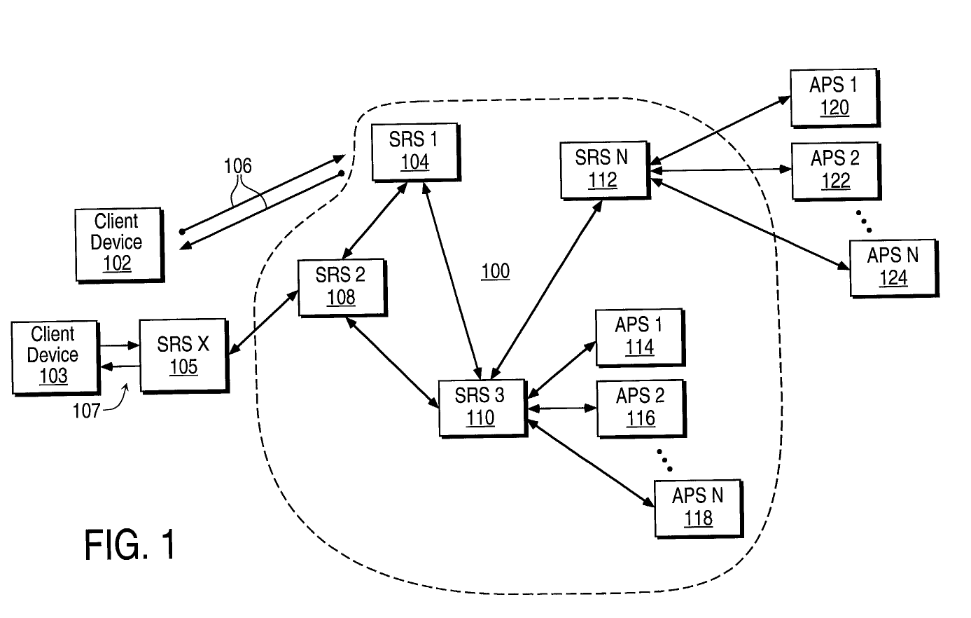

Referring to FIG. 1, a diagrammatic view of a network system 100 employing the invention is illustrated. The network may be a local area network (LAN), the Internet, a dedicated network, other network configuration or even combinations of networks. Similar to a conventional system, system 100 is responsive to client devices 102, 103. These client devices may send client requests targeted for services, and usually are not directed to particular service providers. In conventional systems, in order to find a service provider of a particular service, a client, or user, is left to search out for a service provider via a web searching site or other similar means. In contrast, a system employing the invention would allow a client to more intelligently and efficiently search for a service provider.

In one embodiment of the invention, a client device 102 may send a request for a service to a service routing server (SRS), such as SRS 1, 104, via signals 106. An SRS is an example of and ingress server. Such a server may be a server that provides and entry into the service routing network for a client to send requests for services or otherwise communicate with an SRS or another server affiliated with the network. Such a server may also serve as an egress server from the network to a client, configured to deliver data or services to a client. Depending on the service network configuration, as well as the type of service provider service that is being provided to a particular client, the ingress and egress of the service data or other service may be different. For example, in most applications, the service provider server will deliver the service directly to the client after it is routed to the service provider server. Either the ingress server or egress server may also serve as an internal routing engine for the service routing network, or other type of routing between clients and associated service provider servers.

The configuration of such a signal 106 may be tailored to a specific network application, or may be conventional TCP/IP protocol, which is commonly used in many computer communications applications. In wireless applications, such as personal data assistants (PDAs), a TCP/IP/PPP protocol may be used for communication between a PDA and an SRS or intermediate device to send requests. Such a system is illustrated as device 103, communicating with SRS X 105. In other wireless applications, TCP/IP/MIP, a mobile IP configuration, may be used. The SRS may be a LAN access point (LAP), or other communication interface, configured to enable the transmission of signals 107 between the client device 103 and system SRS 2, 108. Whether the client device is of any particular configuration, the common goal of users of such device the desire to easily and conveniently seek out and find service providers for particular services. The invention is not limited to any particular communication protocol or medium on which communication signals are sent.

Within system 100, associated SRS' may be of virtually any number. Illustrated are SRS 1, 104; SRS 2, 108; SRS 3, 110; . . . SRS N, 112; which may be all inclusive or simply part of a larger affiliated network. Such a network may be configured as a dedicated network with dedicated connections, and having a particular communication protocol. A network may also be configured with a virtual association, wherein one or more SRSs in the association monitor the status of other servers within the association. According to the invention, with the existence of such an association, the servers may form a universal affiliation with each other that enables them to direct clients to each other according to the client requests.

Each SRS may perform particular services itself or it may be affiliated with other SRSs that perform services. It my also be connected to one or more application servers that perform one or more different types of services. In either configuration, an affiliation with other servers, whether they be SRS type servers or application servers (APSs), an affiliation with other servers establishes the ability to dynamically route client requests to service provider servers according to the invention. Referring again to FIG. 1, SRS 1, 104, is not only able to communicate with client device 102, but is also configured to communicate with SRS 2, 108 and SRS 3, 110. Network connections, or nodes, along with conventional network routing mechanisms and techniques, allow SRS 1 to further communicate with SRSs that communicate on other network nodes. For example, the communication connection existing between SRS 3, 110, and SRS N, 112, allows SRS 1 to communicate with SRS N by implementing modern network communication protocol. Many well-known network communication protocols exist for such an application including the MultiProtocol Switching (MPLS) protocol and other similar protocols. The invention is not limited to any particular network protocol under which signals are configured or to any medium in which data packets or other types of data communication signals are transmitted.

Individual SRSs may be connected or may otherwise communicate with one or more application servers. For example, SRS 3, 110, may communicate and be affiliated with application servers (APS) APS 1, 114; APS 2, 116; . . . APS N, 118. These application servers may be connected to SRS 3 via a dedicated connection. They may also be associated with SRS 3, wherein the status, operating parameters and other information are monitored and maintained by SRS 3, so that SRS 3 may offer out the services of the application servers to the rest of the affiliated servers. With SRS 3's affiliation with the other SRSs at the other communication points, which may be nodes within a network, other SRSs may gain access to the status, operating parameters and other application information.

Similarly, SRS N, 112, may be connected or other wise communicate with application servers APS 1, 120; APS 2, 122; . . . and APS N, 118 to affiliate itself with them, and likewise affiliate the application servers with the network. This particular configuration may allow the SRS N to control the affiliation of its personally affiliated application servers with respect to the rest of the network system 100. In some service applications, it may be desirable to keep the application servers more secure from the rest of the network, where even information related to their status may be proprietary. SRS N may then act as a barrier to the application servers, protecting their information from the outside world, while possibly still making their services available to clients via the other SRSs within system 100.

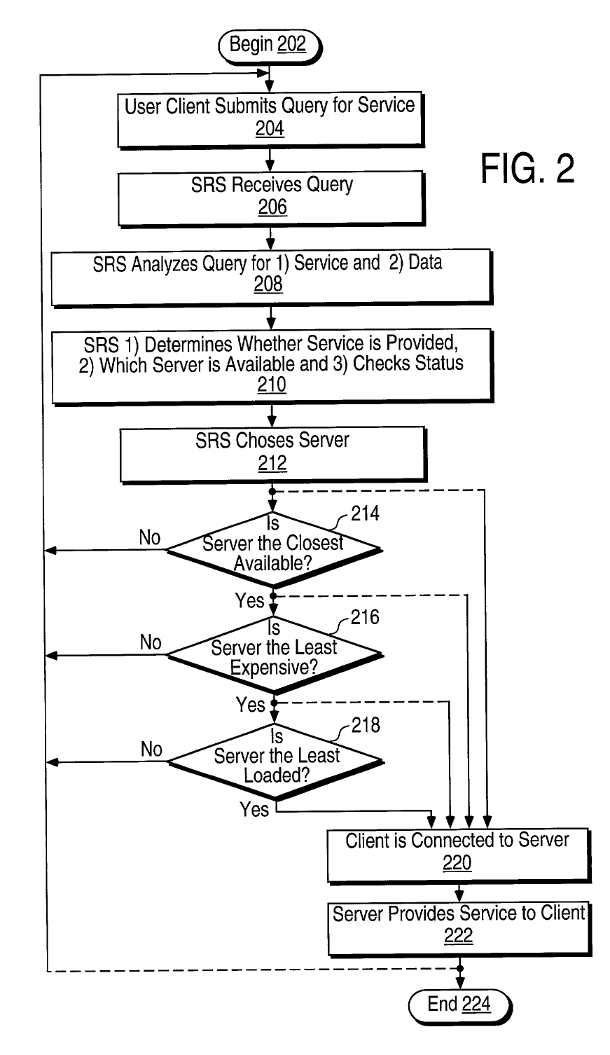

With these different configurations, SRSs have access to their respective application servers. Using their respective affiliations, other SRSs may help to make the application servers' services available to client devices 102, 103. According to the invention, utilizing this affiliation, the system 100 may be configured to intelligently connect clients to SRSs and application servers, providing an easy and efficient manner of providing services to clients. Referring to FIG. 2, a flow diagram is shown to illustrate one embodiment of the invention, where the affiliation among servers, both service routing servers (SRSs) and application servers (APSs), allows the system as a whole to provide fast and intelligent selection of service provider servers in response to client requests.

The process begins at step 202. In the first instance, in step 204, a user or client may submit a query for a particular service. The service may be a particular service to be performed, such as video data editing or other modification. A client may specify the desired service with particularity, so that a specialized service provider server may be found, if it exists. Information may be provided by the user such as the client device or system specifications or parameters, specific service details, location of the client system, preferred cost range of the service, or other information that a user communicating with the system may feel is important in determining which service provider to use. The request signal is sent to an SRS that receives it in step 206. In step 208, the SRS analyzes the request, possibly separating out the request from any data that may be sent with the request. The SRS may then be more able to parse out the request particulars and determine which servers may be best suited to provide such a service.

In step 210, the SRS may use the information sent with the request to determine whether a service provider has services affiliated with the system that may be responsive to the request. The SRS may determine whether a service is actually provided by it or an affiliated server according to the request parameters. If there are servers that pertain to the service being requested, the SRS may also determine whether the relevant servers are available to perform the service. Such servers may be down, may be overloaded or have other issues that may render it incapable or even inconvenient for providing the service to the client. Generally, the SRS may check the status of relevant servers. In step 212, the SRS may choose a particular server or servers that are relevant to the client request.

In some embodiments of the invention, other layers of qualification may be performed on the request. FIG. 2 illustrates three different possible qualifications that may be performed in choosing a server. One or all of these steps may be bypassed in particular embodiments by proceeding directly to step 220, where the service provider server is connected to the client to perform the service. If not bypassed, the process proceeds to the further qualifications steps.

Step 214 may be implemented to determine whether a particular server is located close. The determination may be based on a relative comparison of two or more servers with respect to their geographical locations, or other criteria. In many applications, the transmission of data may break down over distances. Also, transportation of data may be expensive, and may require substantial resources of a network application. For example, referring again to FIG. 1, if a client request for a service requested by client device 201 may be available in both servers SRS 2 and SRS N. Assuming that these devices are located in relatively remote locations, it would make sense to choose the server that is located geographically closer to the client. This way, you would not need to route the service request and subsequent result through the other servers along the path between SRS N and SRS 1 (which acts as the ingress and egress processor for the client device). Such a path may include sending data through different nodal connections such as from SRS N through SRS 3 and SRS 2 and SRS 1 to the client. Another path may be from SRS N through SRS 3 and SRS 1 to the client. If a server is located closer to the client, such paths may be eliminated, freeing the other paths and nodes up for other signal transmissions.

Still referring to FIG. 2, in step 216, another optional qualifying step may include determining whether a particular server is the least expensive for the service. This determination may again be relative to other service providers, or may be determined based on a predetermined range of values. This may also be related to step 214, where the traveling distance of the signal may affect the cost of the service provided by a particular service provider.

In step 218, a determination may be made as to whether the server is the least loaded among the servers chosen. This is a good feature to monitor for load balancing purposes. This may again be determined based relative to the loads of other servers that are chosen, or may be based on a predetermined threshold. In certain services, the availability of a server may not be the most important criteria for choosing a particular server to provide a service based on a request. Some services may not be possible, or many not be useful if provided by a server that is overloaded. It may even cause a failure in the service.

These and other qualifications may possibly be implemented in determining which service provider server is best to respond to a given client request. In a preferred embodiment, tables of service provider tables are propagated throughout a system in order to update each SRS with relevant properties information of qualified application service providers. This is discussed in more detail below. Whichever types of qualifications are implemented, the process eventually proceeds to step 220, where a service provider server is connected to the client to provide the requested service. The process then proceeds to step 222, where the service is provided to the client. The process may then end at step 224, or may proceed back to step 204, where a user may submit another request for a service.

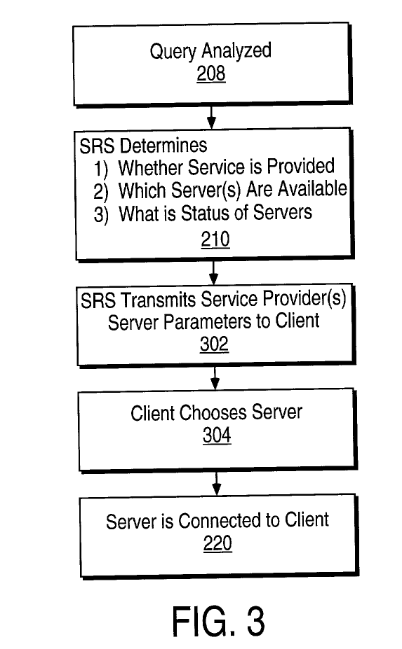

Referring to FIG. 3, an alternative embodiment for determining which service provider server to choose is illustrated. The process of FIG. 2 may be performed up to and including step 210. Then, in the alternative method shown in FIG. 3, the process proceeds to step 302, where the SRS is configured to transmit the parameters of a service provider server to a client for qualification. The client may then choose its own service provider server in step 304. This determination may be done by a user responding to a graphical user interface that may prompt a user to choose among a number of service providers that offer a service that is responsive to a client request. This list of providers may be pre-selected by an SRS ingress server, which is affiliated with other servers, and which has information on such servers that can be used by either the SRS or the client device to qualify them. The list may then be provided to the client device to qualify and ultimately choose a service provider in step 304. The service provider server may then be connected to the client. Referring back to FIG. 2, the process may then proceed to the end of the process at step 224, or back to the beginning to step 204.

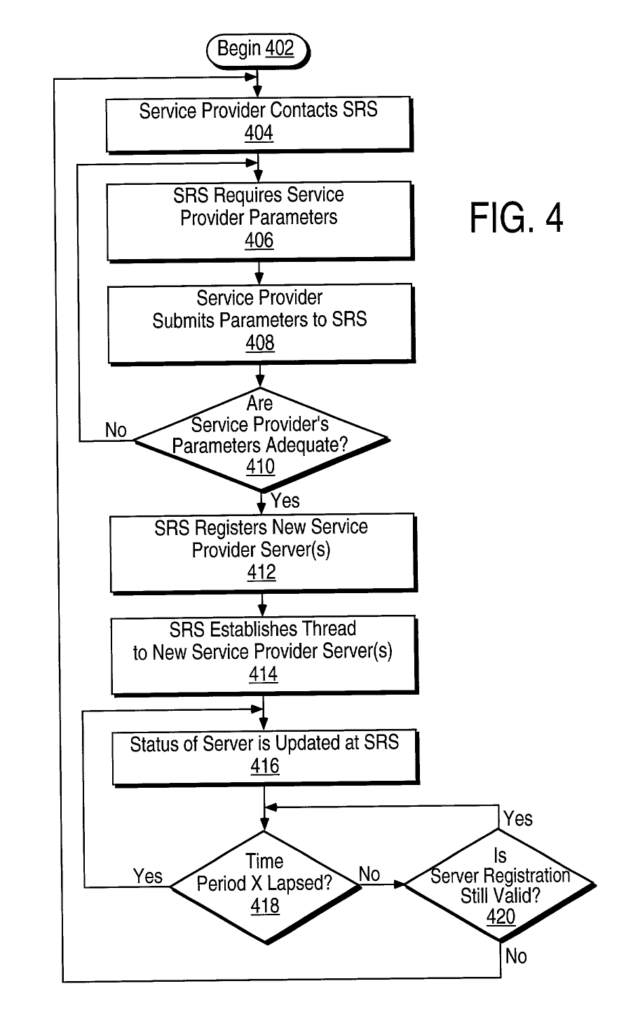

According to the invention, the system may also be configured to affiliate and associate new service providers with the system. This could allow for SRSs within the system to register and pre-qualify servers to be affiliated within the network. Referring to FIG. 4, a flow chart is shown to illustrate one embodiment of the invention, where service provider servers may be associated within the system. The process begins at step 402, followed by step 404, where a service provider contacts an SRS that is already affiliated with the system. This contact may be by way of electronic messaging, where an SRS is configured to receive information from the outside server, qualify the server, and possibly associate the server within the system. The interaction may be a simple request by the outside server to affiliate with servers in the system. The outside server may be required by the SRS in step 406 to submit its service parameters to the SRS in step 408. The parameters may include the server's availability to perform its services, and may also include the breadth of services that it offers, costs of products and services, and other details pertaining to any proposed services. The outside server may further be required to submit information related to its operating capacity, communication protocols, geographical location, hardware and software requirements for communication with the outside server, and other information that may be relevant to associating an outside server.

Once the outside server's parameters are received and somehow reviewed by the SRS, the SRS may be configured to qualify the adequacy of the submitted parameters in step 410. In one embodiment of the invention, an SRS may be configured to require certain parameters before qualifying an outside server. In order for the system to be able to refer client requests to pre-qualified service provider servers according to the invention, certain information must be known about the servers. According to the invention, when a client requests a particular service in the form of a client, it is expected that only relevant service providers will be referred for the service. In order to do this, the SRS must be informed of the service provider's parameters and other information. The pre-qualification may therefore initially require that certain information be adequately provided before the quality or adequacy of the outside server may be assessed. If the parameters provided are not adequate, then the SRS may again require that the parameters be provided, perhaps be returning the process back to step 406, or corrected and submitted again before the outside server may be qualified. Once the parameters are adequately submitted, the outside server may then be qualified and associated with the system.

The system may be further configured overall to encompass certain standards for pre-qualifying outside servers. In other words, the adequacy of the parameters submitted by the outside server may be put through a higher level of scrutiny by the SRS in step 410 before being qualified. The server may be required to go through further qualifications such as performance testing or subjective product quality testing. In one embodiment, the outside server may be reviewed down to its content and service processes for various reasons. In other embodiments, less qualification on the substantive service may be required in order for association within the service routing network. This may be the case where the communication and service delivery negotiation is left to the application server and the client.

Once qualified, the SRS may then register the new service provider server(s) in step 412. This may entail recording and indexing the server identity along with its parameters. According to the invention, the service routing network may be configured to update the associations of affiliated SRSs and application servers by propagating service provider tables throughout the system. Such a table may include information as illustrated in Table A.

TABLE A

| Service | | | | | |
|---|---|---|---|---|---|
| Provider | Services | | Availa- | Client | Qualifi- |
| Server | Offered | Properties | bility | Capacity | cation |
| Video.srv | Video | Geo. Loc.: | Up and | 1500 | Qualified |
| | Editing, | Northern | Running | | by SRS |
| | Content | California | and | | 10002. |
| | Edition and | Com.: T1 | Available | | |
| | Enhance- | | | | |
| | ment | | | | |
| Audio.srv | Audio File | Geo. Loc.: | Server | 900 | Qualified |
| | Editing, | Northern | Down, | | by SRS |
| | Copying and | California | Not | | 10002 |
| | production | Com.: T1 | Available | | |

Throughout the system, these parameters may be shared with other SRSs at other nodes. According to the invention, each SRS may have a look-up table of service provider server parameters, which allows each SRS to locate service provider servers that are relevant to particular client requests. This way, at any one node, an incoming client request may be routed to a service provider that is able to respond to the request. These look-up tables may be updated periodically in order to keep every necessary SRS in the system knowledgeable and aware of application service provider servers that may be available.

Each ingress server may include a router table propagator for propagating the routing tables related to application servers. In a preferred embodiment, the routing tables related to each respective application server or service provider server may be intelligently propagated to each SRS to update each SRS whenever an update occurs to the routing table. For example, a service provider server may change its geographic location, its service offerings, or its Internet protocol (IP) address. As a result of the change, the routing table changes may be propagated throughout the affiliated network so that all SRS nodes are informed of the change. In a preferred embodiment, the routing table is propagated via a multicast scheme, a method known in the art of network computing. Another method of propagation is via a broadcast scheme, wherein updated routing tables are sent to every SRS simultaneously, which is also well known in the art.

In step 414, the SRS may establish a monitoring thread to the newly associated service provider server. This thread may be a software application that is configured to communicate between the service provider server and the SRS. Such a thread may allow an SRS to monitor the server in order to update its status information, such as in step 416. Such updates may occur periodically or on demand, and may be initiated by either the SRS or the service provider server. Such updates would allow a system to consistently maintain the status of service provider servers throughout the system, providing a robust network of severs that is reliable and that can be qualified for client requests. In step 416, the status of a server is updated. In the following step 418, a timer may be established to periodically check the status of the server. In one embodiment, after a predetermined period of time, the status is checked, and the status information of the server is updated at the SRS. In between time periods, the SRS may monitor whether the registration of the server is still valid in step 420. If it is still valid, then the process continues with the status monitoring. In contrast, if it is not valid, then the process may be terminated, and possibly resumes back at the beginning, step 402.

In another embodiment of the invention, a subscription configuration is embodied in the service routing network. In this configuration, the SRSs affiliated with the service routing network system knows the subscription that a client may hold with a particular service provider and routes the service request directly to that service provider. In a subscription mode, the service providers may actually pay for the service routing network to route service requests to their servers. Therefore, the service routing network does not need to be concerned with qualifying the service provider servers. The quality of service, availability, capacity or other properties of a particular provider remain the service provider's responsibility. Another way of characterizing this configuration is consider the client device as associated or otherwise affiliated with the system. The client may be associated in the sense that it has a pre-configured relationship with one or more associated service provider servers.

On the other hand, in a related embodiment, the service routing network may be able to monitor whether the service provider is satisfying the client's requests, possibly through the associated application server. If client request is frequently not satisfied by it, subsequent requests may no longer be routed to that service site. Therefore, the service provider would want to make sure the service it provides is functional and satisfactory all the time.

Browser request represents one type of service request. A browser request may be characterized as an end user asking for a service through a web interface, such as a typical Internet web browser connected to the World Wide Web (WWW). However, there are other types of request and the request maybe from different types of clients.

For example, in one embodiment, the client could be a content delivery service provider. Such a provider may distribute content. Such a provider may also provide the ability to distribute information by delivering content more directly to clients than conventional servers, and more quickly. This is known in the art as pushing content closer to network edge. One such content delivery service provider is Akamai.

In yet another embodiment, the client may also be a content provider, such as news delivery provider CNN. In this configuration, CNN may publish a news video clip on its web site. The video clip may be of high quality and high resolution. As a result, the high quality clip would require a high bit rate communication channel for the delivery and would further require a high resolution client device for quality viewing of the clip by a user. Such a clip would not be suitable for viewing by wireless or personal data assistant (PDA) type of devices. However, CNN would want the high quality content to be viewable on any client device, but does not want to go through the trouble of generating different versions of the same content for different types of devices that wish to view the high quality clip.

Therefore, according to the invention, CNN may subscribe to a content adaptation service via the service routing network, delegating to the adaptation service the task of adapting their content for use by devices running on different bit rates. Using such a service, CNN would be able to simply create and deliver one video clip, and the content adaptation service can adapt to disparate devices as needed. Then, whenever the clip is requested by a wireless type of thin client for example, the original video clip is sent to a service site, routed by the service routing network, for bit rate adaptation. The service provider can, for example, change the bit rate of the clip from one rate, such as 1.5 mega bits per second, to another rate, such as to 100 kilo bits per second. Now the clip can be delivered through a low bandwidth, wireless channel to the end user. To the same end, the SRS in such a configuration may not need detailed parameters for certain type of service in order to route the service. This is because the service request can be routed to a service provider server, and subsequent negotiation of the service may be initiated between service provider server and the client.

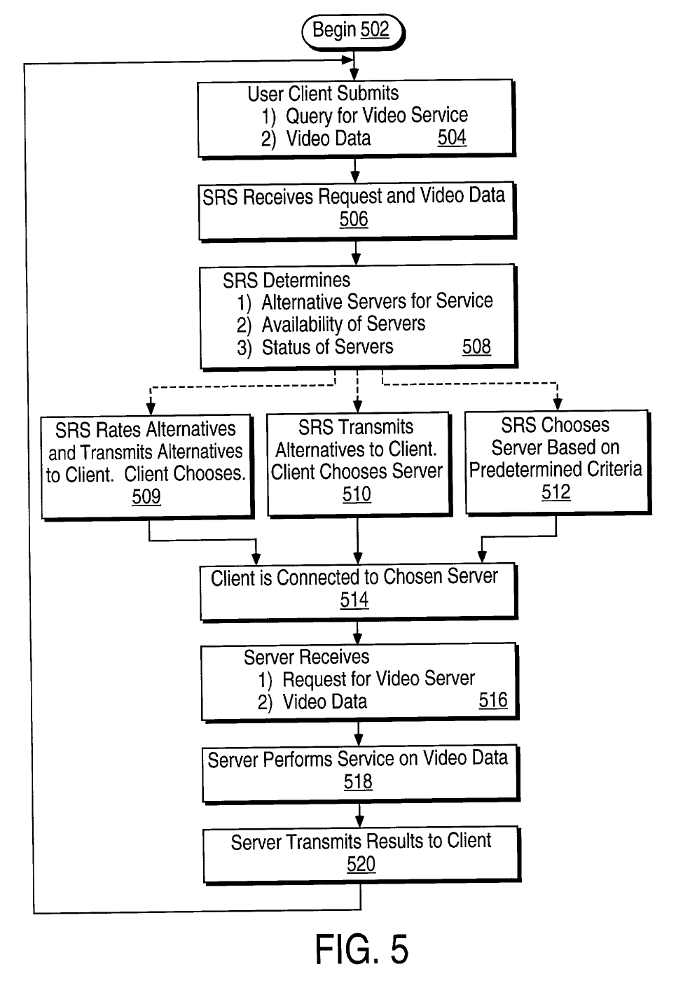

The invention may be embodied in any one of many service provider areas, video editing for example. Video editing is a very common and useful service performed by vidiographers. Wedding videos, for example, may be greatly enhanced by editing out dead space, adding content such as titles and background music, rearranging sections of video, and otherwise modifying the content. Referring to FIG. 5, a flow diagram of such a system is illustrated. The process begins at step 502. In step 504, the client submits a client request. In this embodiment, the query may be sent along with video data for processing. In other embodiments, the query and selection of the service provider server may be resolved before the data is actually sent. However, if the service provider network is able to provide the particular service by utilizing adequate pre-qualified servers, and if clients have confidence in the system, then it would be feasible to send data along with the requests for services. In step 506, the SRS receives the request for services along with the data, and analyzes it. The SRS then determines which servers to refer for the service in step 508. The SRS may determine one or more alternative servers for the service, and may even rate them according to their relevance to the service requested. The SRS may also determine the availability of the service provider servers, as well as any status available on the servers.

With this information, the system may perform one of three subsequent steps. In one embodiment, step 509 would rate alternatives of servers pre-qualified by the server according to certain criteria. These alternatives would be transmitted to the client for a selection. In a second embodiment in step 510, the SRS may transmit alternatives without a rating, and would wait for the client to choose one. In a third embodiment, the SRS itself may choose a server based on predetermined criteria in step 512, without any input from the client. Other possible scenarios, including different combinations and permutations of these examples, as well as other similar examples are possible.

Proceeding to the next step 514, the client may then be connected to the chosen server. Once this is done, the server may receive both the request for video service and the video data in step 516. The sever may then perform the service on the video data in step 518, and then transmit the results to the client in step 520.

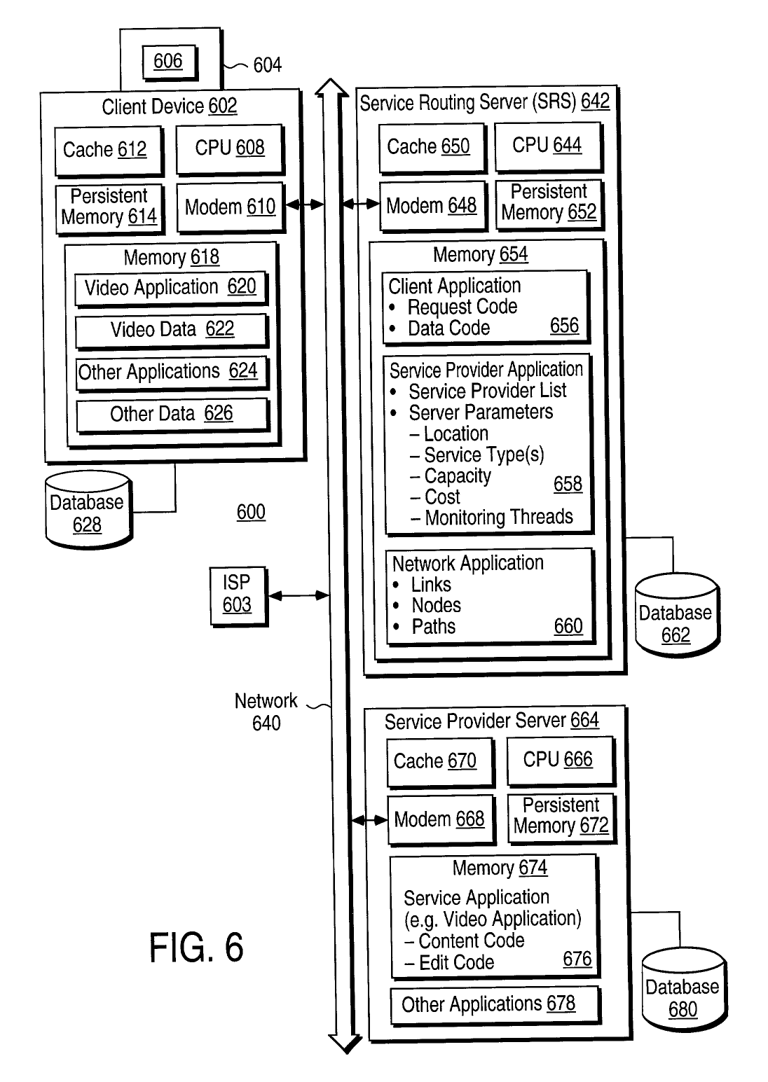

Referring to FIG. 6, a more detailed block diagram of a dynamic service routing system is illustrated. The system 600 may include a client device 602, which may communicate with an Internet service provider 603 to communicate via the Internet. The device may further include a monitor 604 having a screen 606 for a user to view, among other things, data pertaining to a client request sent to an SRS. The client device may further include a CPU 608 configured to execute electronic software code to perform basic processing functions, including sending client requests over a network. A modem 610 may be included for communicating between the client device and a network 640. The device further includes cache memory 612 for storing data for easy access by the CPU, and may further include persistent memory 614 for storing data that is frequently used by the CPU. Memory 618 is also included for storing software applications and data relevant to the functions of the client device. Video application 620, for example, may be executed by the CPU 620 to perform video functions such as storing and viewing videos embodied in video data 622. Other applications 624 and other data 626, as well as optional database 628 may also be included in memory for performing other tasks within the client device.

The system may further include an SRS 642 configured to dynamically route client requests to service provider servers according to the service request embodied in the client request. Similar to the client device, the SRS may include a CPU 644, configured to execute electronic software, causing the SRS to perform routing functions. Modem 648 is included for communicating on network 640. Cache memory 650 is included for storing data for fast and easy access by the CPU. Persistent memory is also included for providing fast access to data frequently used by the CPU. Memory 654 is configured to store applications related to dynamically routing client requests to service provider servers. Client application 656 is configured to work with request code and data code to receive client requests and related data, respectively, and parsing out information relevant to routing the request. Service provider application 658 is configured to develop and maintain associations with other SRSs as well as associated application servers. The service provider application may include lists of service providers along with the parameters of the service provider servers. These parameters may include locations of the particular servers, the types of services offered by individual servers, the capacity of individual servers, the cost of the services offered by individual servers, and other parameters that are useful to the routing of client requests. The application may also include code related to maintaining monitoring threads with service provider servers, which may allow an SRS to be updated as to the status of any particular server. This information may also be propagated throughout the system as discussed above. This parameter information would be useful to an SRS in routing clients to service provider servers. A network application 660 may also be included for maintaining records and configurations of links, nodes and paths within the network. This code may be useful in the routing of client requests among associated servers when seeking out service provider server to which to send the client requests. The SRS may optionally have access to database 662 for storing and retrieving data therefrom.

The system 600 may also include one or more service provider servers 664, which, like the other devices discussed, includes a CPU 666, configured to execute electronic software code pertaining to the service that the server 664 provides in response to client requests. The server may include a communication device such as a modem 668 or a network card (not shown) for communicating with network 640. Communication interfaces may be of many forms, accommodating possibly modem communications, DSL and T1 communications, and other media communications. The server may also include cache memory 670 and persistent memory 672 for providing fast access to data by the CPU, similar to that discussed above. Memory 674 may include a service application 674, which includes software code that, when executed by the CPU, causes the service provider server to perform the functions related to the provision of services in response to client requests. Services such as that provided by a video application 676 may be performed by the execution of such software code. Such a video application may include content code and editing code for performing video services on video data. Service provider server may also include other applications code 678 for performing other server operations, and may also include access to database 680 for storing and retrieving data therefrom.

In general, the invention may include the utilization of dedicated processors, webservers configured to receive and route client requests, application servers, state servers and other types of computer processors configured to communicate amongst each other and that may be connected to one or more networks, including a Local Area Network (LAN), an intranet and the Internet. However, it will be appreciated by those skilled in the art, such implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using programming languages such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively.

The apparatus and method include a method and apparatus for intelligently routing client requests to service provider servers. Although this embodiment is described and illustrated in the context of a routing client requests to servers providing services, the scope of the invention extends to other applications where efficient routing of information is useful. Furthermore, while the foregoing description has been with reference to particular embodiments of the invention, it will be appreciated that these are only illustrative of the invention and that changes may be made to those embodiments without departing from the principles of the invention, the scope of which will be defined in subsequent utility applications claiming priority based on this application.

1. A network configured to dynamically and intelligently route requests for services provided by service provider servers, comprising:
an association of at least one service provider server;
an ingress server configured to receive incoming requests for services that are directed to the network;
a routing device configured to intelligently route the client service request to an associated service provider server according to predetermined criteria; and
a service provider server register configured to maintain current service provider server information.

2. A network according to claim 1 further comprising a qualifying device configured to intelligently qualify a service provider server according to predetermined criteria, wherein the service provider server may become associated with the network.

3. A network according to claim 2 wherein the qualifying device is configured to qualify a service provider server based on service quality criteria.

4. A network according to claim 2 wherein the qualifying device is configured to qualify a service provider server based on service routing criteria, and wherein the routing device includes routing code for enabling a processor to route client requests to an application service provider server by executing the routing code.

5. A network according to claim 2 wherein the qualifying device is configured to qualify a service provider server based on the type of service offered by the service provider server.

6. A network according to claim 1, wherein the network includes a plurality of routing devices and a router table propagator configured to intelligently propagate updates of routing tables that may exist in each of the plurality of routing devices.

7. A network according to claim 1, wherein the ingress server includes a routing device configured with routing code to route client requests to an application service provider server and a service provider server register configured to maintain current service provider server information.

8. A network according to claim 1 further comprising a plurality of service provider servers that are affiliated with the ingress server, wherein the ingress server is configured to route client requests to one or more of the service provider servers according to predetermined criteria.

9. A network according to claim 1, wherein the service provider server register includes a routing table containing property information pertaining to a service provider server.

10. A network according to claim 1, wherein the service provider server register includes a routing table containing property information pertaining to a service provider server including operation status information and type of service information.

11. A network according to claim 9, wherein the routing table includes a look-up table containing property information pertaining to a service provider server that can be looked up by the routing device.

12. An ingress server configured to route a client request to an application server, comprising:
a router configured with routing code to route client requests to an application service provider server; and
a service provider server register configured to maintain current service provider server information.

13. An ingress server according to claim 12 further comprising a qualifying device configured to intelligently qualify a service provider server according to predetermined criteria, wherein the service provider may become associated with a service routing network.

14. An ingress server according to claim 13 wherein the qualifying device is configured to qualify a service provider server based on service quality criteria.

15. An ingress server according to claim 13 wherein the routing device includes routing code for enabling a processor to route client requests to an application service provider server upon execution, and wherein the qualifying device is configured to qualify a service provider server based on service routing criteria.

16. An ingress server according to claim 13 wherein the qualifying device is configured to qualify a service provider server based on the type of service offered by the service provider server.

17. An ingress server according to claim 12, wherein the network includes a plurality of routing devices and a router table propagator configured to intelligently propagate updates of routing tables that may exist in each of the plurality of routing devices.

18. An ingress server according to claim 12, wherein the service provider server register includes a routing table containing property information pertaining to a service provider server.

19. An ingress server according to claim 12, wherein the service provider server register includes a routing table containing property information pertaining to a service provider server including operation status information and type of service information.

20. An ingress server according to claim 12, wherein the routing table includes a look-up table containing property information pertaining to a service provider server that can be looked up by the routing device.

21. An ingress server according to claim 12, further comprising a subscription module configured to route a client request to a service provider server according to subscription criteria.

22. A method for routing a client request to a pre-qualified service provider server, wherein such routing is performed by a routing server having a service provider register, comprising:
receiving a client request;
analyzing the client request to determine the type of service that is requested by the request;
checking the service provider register for a pre-qualified service provider server that is capable of performing the requested service; and
routing the request to a service provider according to predetermined criteria.

23. A method according to claim 22, further comprising the step of choosing a service provider server from a number of service provider servers that have been pre-qualified by the routing server for particular services.

24. A method according to claim 23, wherein choosing a service provider server from a number of service provider servers is performed by the routing server according to predetermined subscription criteria.

25. A method according to claim 22, further including intelligently propagating router table updates to service routing servers.
